(19) United States
(12) Patent Application Publication
(10) Pub. No.: US 2004/0209027 A1
(43) Pub. Date: Oct. 21, 2004

(54) Slip collar

(75) Inventors: Raymond Wellman, Vallejo, CA (US); Jeff Shea, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ATS Products, Inc., Richmond, CA (US)

(21) Appl. No.: 10/765,707

(22) Filed: Jan. 26, 2004

Related U.S. Application Data
(63) Continuation-in-part of application No. 10/368,028, filed on Feb. 19, 2003.

(51) Int. Cl. B32B 1/08

(52) U.S. Cl. 428/36.91

(57) ABSTRACT

A slip collar is disclosed. The slip collar comprises a tubular outer wall portion, a tubular inner wall portion, and an intermediate portion disposed between the tubular outer wall portion and the tubular inner wall portion. At least one of the tubular outer wall portion, the tubular wall inner portion, and the intermediate portion comprises a fiber reinforced plastic material.

### CROSS-REFERENCES TO RELATED APPLICATIONS

This patent application is a continuation-in-part application of U.S. patent application Ser. No. 10/368,028, entitled “Slip Collar For Joining Fume Duct Sections” filed on Feb. 19, 2003. This U.S. Patent Application is herein incorporated by reference in its entirety for all purposes.

### BACKGROUND OF THE INVENTION

Ductwork for corrosive vapor exhaust systems is used extensively in many diverse industries, which utilize corrosive or hazardous chemicals to process raw materials or perform manufacturing procedures. Such industries include the semiconductor, plating, wastewater treatment, and pharmaceutical industries. Such ductwork also is required in the many research and development laboratories, which use highly reactive, toxic or otherwise hazardous chemicals. Such chemicals not only can put workers at risk to hazardous fumes, but are also potential sources of contamination and corrosion. Consequently, vapors from hazardous chemicals must be exhausted through leak-proof air ducts to safely remove them from work areas. Duct installations can be very large, consisting of many thousands of feet, of ductwork, which may be manifolded and connected to multiple exhaust fans. Forming these duct installations is a time consuming process.

Typically, ducts are fabricated as sections of standard length(s), which are transported to a job site and assembled there. A leak-proof joint is required between each pair of contiguous sections. Even the smallest installation requires a considerable number of such joints. Joints must not only prevent fumes from escaping in day-to-day operations, but must also remain leak-proof after prolonged exposure to corrosive or otherwise reactive chemicals. In some industries, joints must not fail catastrophically in the event a flame propagates through the interior or, if exposed directly to heat such as from a fire external to the ductwork, fail mechanically or become a source of smoke particulates and other contaminants. In some cases, a sealant must be applied circumferentially to each interface.

U.S. Pat. No. 5,549,949 provides a solution to simplifying what had been the most time-consuming step in joining two sections, i.e., preparing the resin-impregnated surfaces to which a sealant bonds in order to form a leak-proof seal. Unless mating surfaces near the ends of each duct section were first sanded or otherwise polished, the interposing sealant layer would not uniformly adhere to the surfaces. Pores would form in the hardened sealant and fumes could leak through the pores. These surfaces include the opposed end portions of the inner laminate surface, the opposed end portions of the outer laminate surface, and the exterior surfaces of a “slip” collar interposed internally between each pair of end sections.

By reducing the time and labor needed to assemble multi-section ductwork, use of the sealant disclosed in the '949 patent can be an important factor in improving the profitability of businesses which sell or install fume ducts. Many installations, however, require joints to have greater integrity to rupture from tensile and flexural loading than can be provided using only mechanical interfacing between the duct sections and slip collar, and sealant bonding. For example, ductwork disposed exterior to a building must be able to withstand flexure due to wind shear. Also, high velocity gases resulting from an explosive chemical reaction within a localized portion of a duct can create a large overpressure, stressing nearby joints even if the duct sections remain intact.

The method disclosed in the '949 patent for reinforcing a joint is to form a “lay-up” bond by tightly wrapping alternate layers of fabric around the joint seam. The larger the duct diameter, the more layers must be used. Each time a dry layer is wound, it must be “wet out”with a resin component of the sealant. Lay-up reinforcement substantially strengthens the joint to the extent that under tensile loading the duct material is likely to rupture before the joint fails. While not as significant a cost driver as sanding, the lay-up method also entails considerable time and labor. Consequently, there is a need for a faster, easier and thereby more cost-effective method for maintaining duct section joint integrity against internal and external tensile and flexural loading. To streamline ductwork assembly, attachment of a device implementing the method is desirably simple and reliable.

Embodiments of the invention address these and other problems.

### SUMMARY OF THE INVENTION

Embodiments of the invention are directed to slip collars, methods for making slip collars, duct assemblies, and methods for joining ducts.

One embodiment of the invention is directed to a slip collar comprising: (a) a tubular outer wall portion; (b) a tubular inner wall portion; (c) an intermediate portion disposed between the tubular outer wall portion and the tubular inner wall portion; (d) a slot region defined by the tubular outer wall portion and the tubular inner wall portion, wherein at least one of the tubular outer wall portion, the tubular wall inner portion, and the intermediate portion comprises a fiber reinforced plastic material.

One embodiment of the invention is directed to a slip collar comprising: (a) a tubular outer wall portion; (b) a tubular inner wall portion; (c) an intermediate portion disposed between the tubular outer wall portion and the tubular inner wall portion, (d) a first slot region defined by the tubular outer wall portion and the tubular inner wall portion; and (e) a second slot region defined by the tubular outer wall portion and the tubular inner wall portion, wherein at least one of the tubular outer wall portion, the tubular wall inner portion, and the intermediate portion comprises a fiber reinforced plastic material, and wherein the first and second slot regions face away from each other.

Another embodiment of the invention is directed to a duct assembly comprising: (a) a slip collar; (b) a first duct including a first end inserted into the first slot region; and (c) a second duct including a second end inserted into the second slot region.

Another embodiment of the invention is directed to a method for joining ducts comprising: (a) providing a slip collar; (b) depositing a first adhesive composition in the first slot region; (c) depositing a second adhesive composition in the second slot region; (d) inserting a first end of a first duct in the first slot region; and (e) inserting a second end of a second duct in the second slot region.

Another embodiment of the invention is directed to a method for making a slip collar, the method comprising: (a) forming a tubular inner wall portion; (b) forming an intermediate portion; (c) forming a tubular outer wall portion, and (d) forming a slot region defined by the tubular outer wall portion and the tubular inner wall portion, wherein at least one of the tubular outer wall portion, the tubular inner wall portion, and the intermediate portion comprises a fiber reinforced plastic material.

Other embodiments of the invention are directed to methods for joining ducts using a slip collar.

### BRIEF DESCRIPTION OF THE DRAWINGS

FIG. 1 is a perspective view of a slip collar.

FIG. 1A is a detailed view of region 1A in FIG. 1.

FIG. 2 is a cross-sectional view of the collar shown in FIG. 1 taken along the lines 2-2.

FIG. 3A schematically depicts the embodiment shown in FIG. 1 where an outer wall portion and seat are fabricated from a first material, and an inner wall portion and seat base are fabricated from a second material.

FIG. 3B schematically depicts another embodiment wherein an outer wall portion and a seat are fabricated from a first material, an inner wall portion and a seat base are fabricated from a second material, and a fluoropolymer film is bonded to an inner surface of the inner wall portion.

FIGS. 4-5 show cross-sections of slip collars according to other embodiments of the invention.

FIGS. 6A-6G show cross-sections of a slip collar as it is being formed on a mandrel.

FIG. 7 shows a cross-section of slip collar with one slot region.

### DETAILED DESCRIPTION

In embodiments of the invention, a “slip collar” may include one or two slot regions and may comprise any suitable length. Some embodiments of the slip collar can be used to join two pieces of duct or pipe without slot regions. In other embodiments, a plurality of slip collars may be joined end to end if one slot region is formed at one end of each slip collar. Thus, the slip collars can be used to join tubular articles or can be used to produce tubular networks such as duct networks or pipe networks. The slip collars may be straight, curved, or may have any other suitable configuration.

One embodiment of the invention is directed to a slip collar comprising a tubular outer wall portion, a tubular inner wall portion, and an intermediate portion. The intermediate portion is disposed between the tubular outer wall portion and the tubular inner wall portion. The tubular outer wall portion, the tubular inner wall portion, and the intermediate portion define a first slot region and a second slot region. The first slot region and the second slot region face outward from each other, and the intermediate portion is between the first slot region and the second slot region.

At least one of the outer wall portion, the inner wall portion, and the intermediate portion comprises a fiber reinforced plastic material (e.g., a fiber reinforced polymeric material). The fiber reinforced plastic material preferably comprises a chemically resistant material and/or a fire-resistant material. Fiber reinforced plastic slip collars are desirable, since they are more universally adaptable to different chemicals than metal slip collars. For example, a metal slip collar may corrode when exposed to certain acids, whereas a plastic slip collar may not corrode as easily when exposed to the same acids. Also, ducts made from fiber-reinforced plastic materials are used in the semiconductor and other industries, and the slip collars according to embodiments of the invention are compatible with those fiber-reinforced plastic ducts. Specific examples of fiber materials and plastic materials are provided below.

Many of the specific embodiments described below refer to the use of a slip collar for joining duct sections. The duct sections preferably include an outer fire-resistant portion and a chemically resistant inner portion. Together, the duct sections and the slip collar may form a duct assembly.

The slip collars according to embodiments of the invention are especially useful for joining ducts. As explained below, in preferred embodiments of the invention, an adhesive composition can be deposited in the first and second slot regions, and two sections of duct can be joined quickly and accurately, without the need for extensive aligning of the duct sections. Thus, slip collars according to embodiments of the invention can be used to “self-align” two adjacent duct sections. In addition, the joint that is formed between connected duct sections is strong and can have fire resistance and chemical resistance. The slip collars include both inner and outer wall portions. They provide better for joint strength and for a better barrier for fumes than slip collars that are made from only a single layer of material. For example, in order for a gas inside of a duct assembly to leak from the interior to the exterior, a gas would have to traverse through the two wall portions of the slip collar and the walls of the duct sections that are being joined. Also, by using the slip collars according to embodiments of the invention, ductwork can be installed quickly and accurately. A duct network that is formed using the slip collars according to embodiments of the invention will be strong and reliable. Although slip collars for ducts are described in detail, embodiments of the invention may be used to join other types of tubular articles such as two sections of pipe.

A number of specific embodiments will now be described with reference to the Figures.

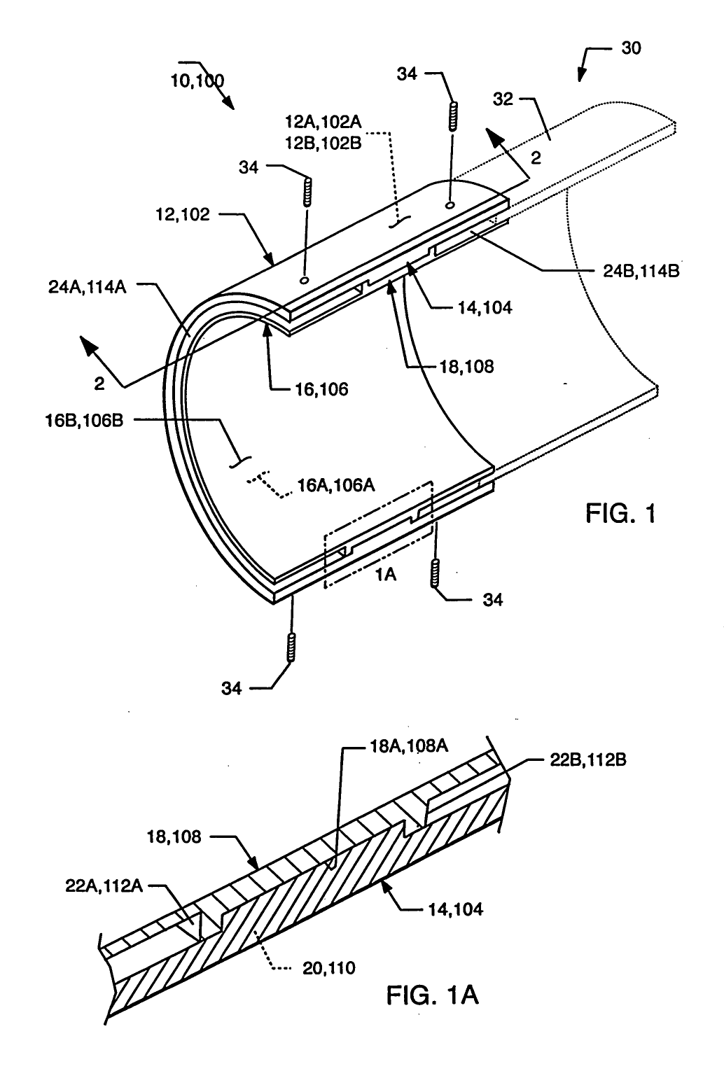

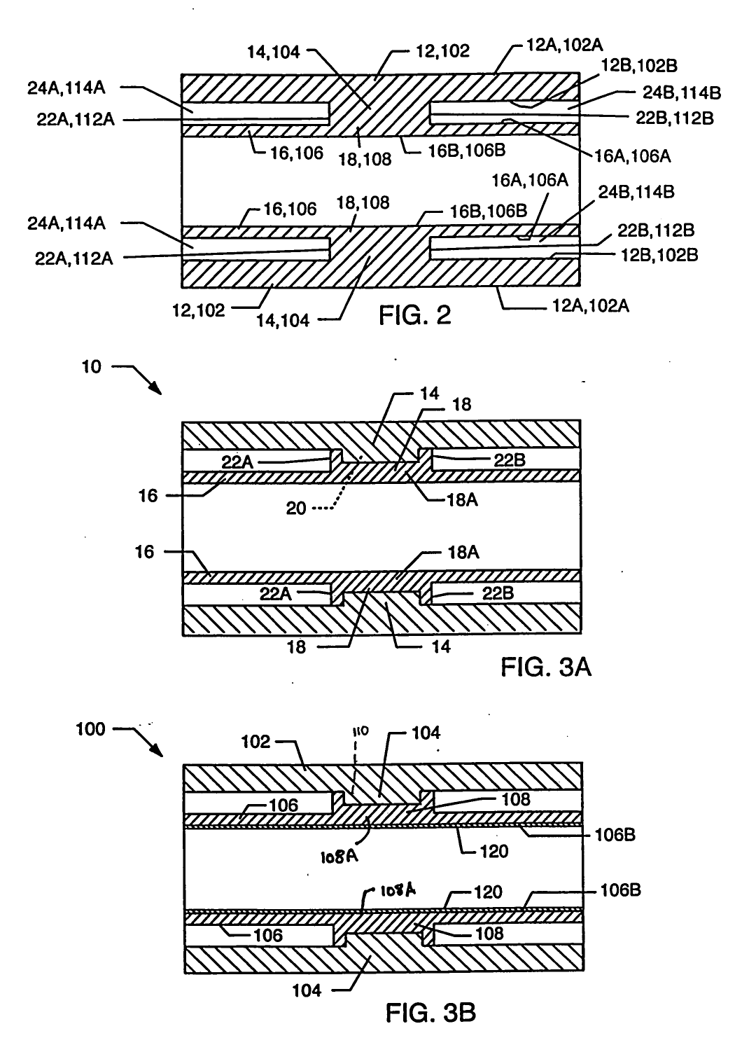

Referring to FIGS. 1, 1A, and 2, in first and second invention embodiments, a slip collar 10, 100, respectively, includes a generally cylindrical outer wall portion 12, 102, respectively, having an outer surface 12A, 102A, respectively, and an inner surface 12B, 102B, respectively, to which is centrally attached a generally toroidal seat 14, 104 formed of the same materials as the outer wall 12, 102. While the use of a generally toroidal seat is described in this embodiment, it is understood that embodiments of the invention are not limited to slip collars with toroidal seats.

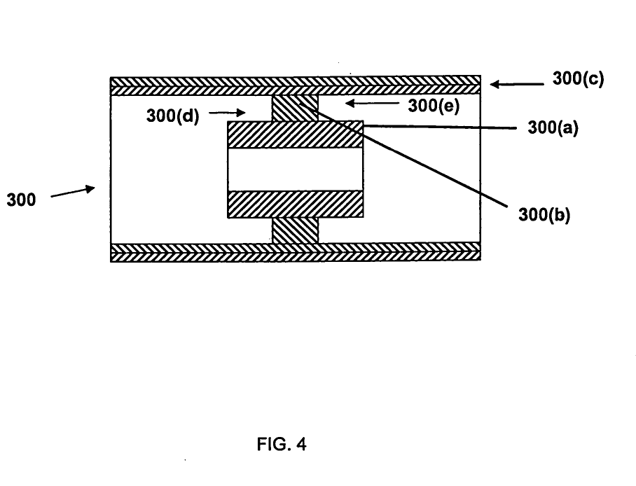

Referring to FIGS. 3A and 3B, the first and second collar embodiments 10, 100 further include, respectively, a generally cylindrical inner wall portion 16, 106 having an inner surface 16B, 106B respectively, a generally cylindrical “U”-shaped seat base 18, 108 having a recess 20, 110 (as also shown in FIG. 1A) respectively, determined by a base portion 18A, 108A, respectively, and opposed first and second sidewalls 22A, 22B and 112A, 112B, respectively (as shown in FIG. 2). Seat base 18, 108 closely receives and is attached to seat 14, 104, respectively. Preferably, the seat base 18, 108 is formed of the same material as the inner wall portion 16, 106, respectively. Alternatively, the inner wall portion and seat base may be formed of different materials.

Outer and inner wall portions 12, 16 and 102, 106 define, respectively, opposed and generally cylindrical first and second slot regions 24A, 24B and 114A, 114B, respectively (as shown in FIG. 2). The region between the first and second slot regions 24A, 24B and 114A, 114B may constitute intermediate portions (or a single circular intermediate portion). As indicated in FIG. 1 by phantom lines depicting the end portion 32 of a duct section 30, each slot region 24A, 24B and 114A, 114B closely receives an end portion 32 of a duct section 30. The end portions of the duct sections can be pre-coated with an adhesive sealant composition and/or the slot regions 24A, 24B, 114A, 114B may include the adhesive sealant composition. Preferably, the adhesive sealant composition includes a settable admixture of curing agent and novolac epoxy resin. Suitable adhesive sealant compositions are described in U.S. Pat. No. 5,549,949, which is herein incorporated by reference in its entirety.

A plurality of set screws 34 may optionally secure the end portion 32 of the duct section 30 to the slip collar 10, 100. As shown in FIG. 1, the formed joint is strong and leakproof. The set screws 34 are useful when the adhesive sealant compositions are curing. For example, an adhesive composition that is produced from a material such as ChemBond™ commercially available from ATS Products, Inc. of Richmond, Calif. may be applied to the walls defining the slot regions with a tongue depressor or squeegee. The end of the ducts that will be inserted into the slot regions may also be coated with the adhesive composition. The duct ends are end inserted into the slot regions and set screws are tightened to hold the assembly in place while the adhesive composition hardens. Excess adhesive composition may be removed. Curing of the adhesive composition can take place by wrapping a drum heater with a temperature regulator set at 180 degrees F. around the center of the slip collar. Heat can be applied for about 5 minutes. Alternatively, a hot air gun can be used to cure the adhesive composition.

FIG. 3A is a schematic representation of a slip collar 10 with an inner wall portion 16 and a seat base 18 formed of the same material. The inner wall portion 16, which can serve as a corrosion barrier and/or chemical barrier in some embodiments, may be made from: (a) an admixture of a phenolic resin and catalyst; or (b) an admixture of a vinyl ester resin and catalyst; or (c) an admixture of an isophthalic resin (iso-resin) and catalyst.

The inner wall portion of the slip collar 10 may have any suitable thickness. The thickness of the inner wall portion 16 when made of phenolic resin can be in a range from about 0.100 to about 0.2000 inch, and preferably is about 0.150-inch. The thickness of the inner wall portion 16 when made of vinyl ester or isophthallic resin can be in a range from about 0.075 to about 0.100 inch, and preferably is about 0.100 inches. The inner wall portion 16 and the seat base 18 can be made different materials.

Depending on the internal pressure which the duct joint is intended to withstand, the height of base 18, as determined by the thickness of base portion 18A and the height of sidewalls 22A, 22B, is in a range from about 3/16 to about 1 inch. The depth of the recess 20 is about one-half the height of base 18 in this example. The thickness of seat 14 equals the depth of recess 20. The outer wall portion 12 and the seat 14 can be made from: (a) an admixture of a phenolic resin and catalyst; or (b) an admixture of a vinyl ester resin and catalyst.

The outer wall portion 12 can have any suitable thickness. For example, the thickness of outer wall portion 12 of the slip collar can be from about 3/16-inch to about 1-½ inches.

FIG. 3B is a schematic representation of a slip collar 100 with the inner wall portion 106 and seat base 108 being formed of the same material. The choices of materials and the ranges of thicknesses for outer wall 102, inner wall 106, seat 104, and seat base 108 can be the same as those for wall 12, wall 16, seat 14 and base 108, respectively.

Slip collar 100 (as shown in FIG. 3B) differs from slip collar 10 (as shown in FIG. 3A) in that a fluoropolymer film 120 is attached to the inner surface 106B or inner wall portion 106 of the slip collar 100. Compared to other plastic materials, fluoropolymers have superior resistance to chemical attack and remain stable at high temperature.

A fluoropolymer film may be bonded to other parts of the slip collar using any suitable process. For example, U.S. Pat. No. 6,441,128 discloses a process for the fluoro-oxidation of ECTFE, which modifies its surface properties so that the film can be adhesively bonded to plastic and metallic surfaces. Other processes are described in U.S. patent application Ser. No. 10/255,125, which was filed on Nov. 25, 2002, and is herein incorporated by reference for all purposes. This process can be used to adhere a fluoropolymer film to a plastic laminate. Other processes, which can be used to bond a fluoropolymer film to a polymeric composite, include plasma treatments, corona etching processes, and sodium etching processes. Fluoropolymer films, which are suitable, may comprise polytetrafluoroethylene (PTFE), fluorinated ethylene propylene resin (FEP), perfluoroalkoxy copolymer (PFA), polyvinylidene fluoride (PVDF) and the like. Preferably, the thickness of film 120 is in a range from about 0.001 to about 0.010 inches. More preferably, the film thickness is in the range from about 0.003 to about 0.005 inches.

The embodiments described above may be made in any suitable manner. For example, the slip collars can be made by molding individual sections of the slip collars and then bonding them together. Alternatively, the slip collars may be formed by molding and then forming the slot regions using a milling process. They could also be made using a mandrel while layering layers of fiber and resin on a mandrel. Some of these methods are described below.

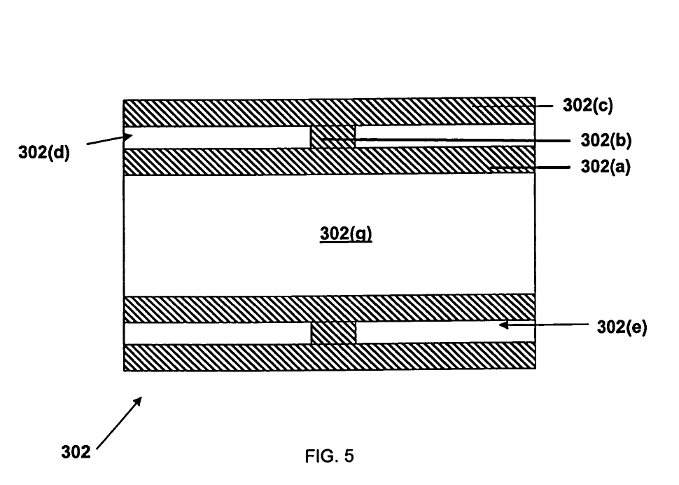

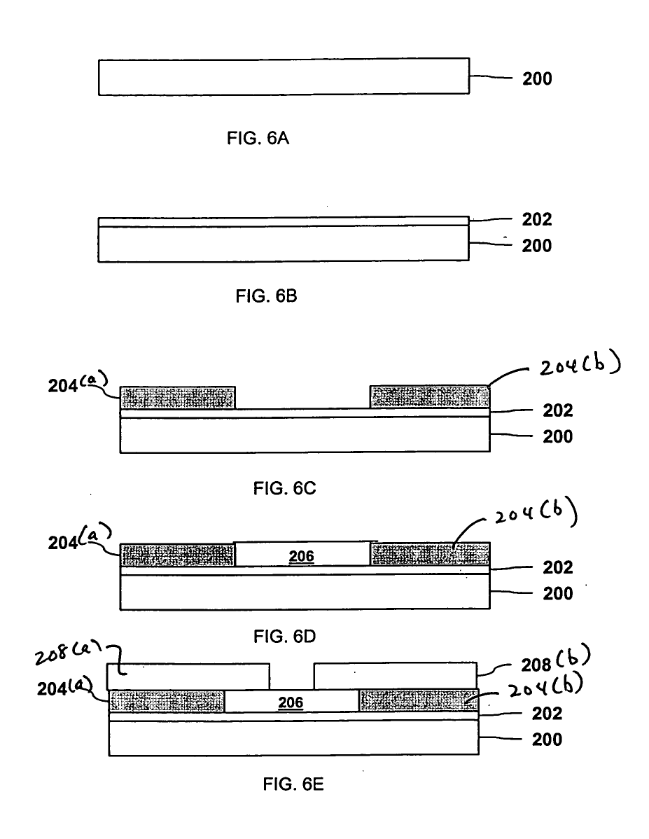

The embodiments that are described above include a slip collar that includes a U-shaped seat portion that interfaces with a toroidal seat. However, embodiments of the invention are not limited thereto. For example as shown in the embodiments below, the slip collars according to embodiments of the invention may include slip collars without U-shaped seat portions that interface with toroidal seats. FIGS. 4 and 5 illustrate slip collar embodiments that do not include U-shaped seat portions or toroidal seats.

FIG. 4 shows a slip collar 300 that includes an inner wall portion 300(a) and an outer wall portion 300(c). An intermediate portion 300(b) is between the inner wall portion 300(a) and the outer wall portion 300(c). The intermediate portion 300(b), the inner wall portion 300(a), and the outer wall portion 300(b) may be considered an integral structure in some embodiments. First and second slot regions 300(d), 300(e) are defined by the inner wall portion 300(a), the outer wall portion 300(c), and the intermediate portion 300(b), and face away from each other. As shown in FIG. 1, duct sections (not shown) are received in the first and second slot regions 300(d), 300(e). As shown in FIG. 4, the inner wall portion 300(a) is shorter than the outer wall portion 300(c). Also, the outer wall portion 300(c) may comprise two distinct layers or could be in the form of a single distinct layer.

FIG. 5 shows a slip collar 302 that includes an inner wall portion 302(a) and an outer wall portion 302(c). An intermediate portion 302(b) is between the inner wall portion 302(a) and the outer wall portion 302(c). First and second slot regions 302(d), 302(e) are defined by the inner wall portion 302(a), the outer wall portion 302(c), and the intermediate portion 302(b), and face away from each other. Duct sections (not shown) are received in the first and second slot regions 302(d), 302(e). As shown, the inner wall portion 302(a) and the outer wall portion 302(c) are of substantially equal length.

While both of the embodiments shown in FIGS. 4 and 5 are suitable for joining sections of duct together, the embodiment shown in FIG. 4 has advantages over the embodiment shown in FIG. 5. As noted, the axial length of the inner wall portion 300(a) is less than the axial length of the outer wall portion 300(c). It is easier to deposit an adhesive composition inside of the first and second slot regions 300(d), 300(e) when the axial length of the inner wall portion 300(a) is shorter than the axial length of the outer wall portion 300(c). Consequently, when joining a pair of duct sections using the slip collar 302, a more reliable joint is formed between them. Joining duct sections is also faster using the slip collar 300 shown in FIG. 4 than the slip collar 302 shown in FIG. 5.

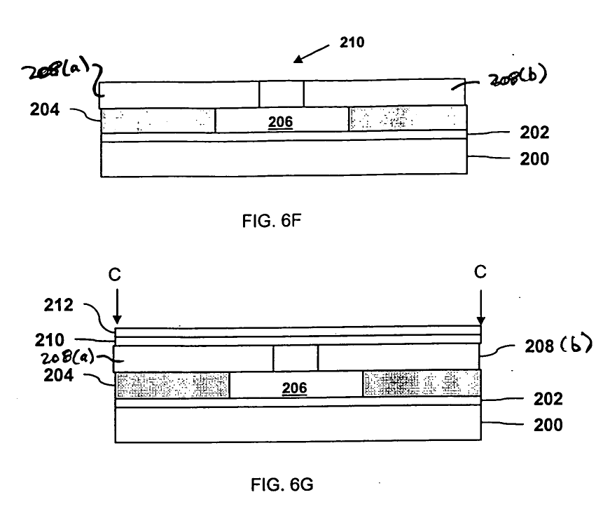

A method for making the slip collar embodiment shown in FIG. 5 can be described with reference to FIGS. 6A-6H. For clarity of illustration, only the top portion of the mandrel is shown. In some embodiments, the method includes forming a tubular inner wall portion, and then forming an intermediate portion. After the intermediate portion is formed, a tubular outer wall portion is formed. A first slot region is defined by the tubular outer wall portion and the tubular inner wall portion, and a second slot region is defined by the tubular outer wall portion and the tubular inner wall portion. At least the tubular outer wall portion, the tubular wall inner portion, and the intermediate portion comprises a fiber reinforced plastic material.

FIG. 6A shows an upper portion of a mandrel 200. The mandrel 200 may be mounted on roller, which can rotate the mandrel 200 so that layers can be formed on it. In some embodiments, the mandrel 200 could be a tapered mandrel, or could be a mandrel with a constant diameter. The mandrel 210 may be made of any suitable material including steel.

The mandrel 210 may also have any suitable diameter. For instance, the diameter of the mandrel 210 may be, for example, from about 2 to about 84 inches in some embodiments. Although the mandrel 210 is in the form of a cylinder, it is understood that the mandrel could have other shapes in other embodiments.

FIG. 6B shows a release layer 202 that is placed on the mandrel 200. The release layer 202 may comprise, for example, a Mylar™ film, and may be used to help separate the formed slip collar from the mandrel 202. As is known to those of skill in the art, a layer of cardboard (not shown) may be placed over the release layer 202. It is possible to place cardboard and/or a plastic film over the mandrel 200 (as in, e.g., U.S. Pat. Nos. 5,308,423 and 5,306,371) to facilitate removal of the formed slip collar from the mandrel 200 after it is formed.

As shown in FIG. 6C, first and second layers 204(a), 204(b) may be wrapped around the mandrel 200 and the release layer 202. The first and second layers 204(a), 204(b) are preferably made of a compressible material such as cardboard. The first and second layers 204(a), 204(b) can be wrapped around the mandrel 200, while leaving a space between them. The space will eventually be used to form an inner wall portion of the slip collar. The spacing of the first and second layers 204(a), 204(b) may be adjusted to the particular length of inner wall portion that is desired. If a longer inner wall portion (e.g., as shown in FIG. 5) is desired, then the spacing between the first and second layers 204(a), 204(b) may be increased.

As shown in FIG. 6D, the space between the first and second layers 204(a), 204(b) is filled with a mixture of resin and a fabric material such as chopped strand mat. For example, a fabric material comprising a three-quarter ounce chopped strand mat impregnated with resin can be wrapped around the mandrel 200.

The layer of fabric material may be wet out with more resin, and then can be rolled out with a fiberglass roller to eliminate air pockets and excess resin in the layer of fabric material. At this point, the saturated layer of fabric material may be cured. Curing may take place spontaneously in some embodiments (e.g., if a resorcinol aldehyde resin system is used) or may take place using heat. Heat may be directed to the resin-saturated fabric material using an external heat source to cure the resin. The curing temperature and time may depend on the particular resin being cured. For example, curing may take place at about 150-180° F. for about 20 to about 30 minutes.

The resin material that saturates the fabric material may include any suitable resin material. A vinyl ester resin is preferably used because of its superior chemical resistance. Suitable vinyl ester resins are commercially available under the tradename Derakane (e.g., Derakane 510A), by Dow Chemical Inc. of Midland, Mich. See, for example, “Factory Mutual (FM Products)” by Spunstrand, Inc. at www.spunstrand.com. Exemplary resins include phenolic resins and vinyl-ester resins. In other embodiments, a phenolic resin such as a phenol-aldehyde resin may be used. A suitable phenol-aldehyde resin is commercially available from Borden Chemical, Inc. Other exemplary resins include resorcinol-aldehyde, or phenol-resorcinol-aldehyde based resin systems. Examples of such resorcinol based systems are in U.S. Pat. Nos. 4,053,447, 4,076,873, 4,107,127, and 5,202,189. U.S. Pat. No. 5,298,299 discusses layers including phenolic resins. All of these patents are herein incorporated by reference in their entirety for all purposes.

The fabric material may be glass, random glass mat, woven roving, boat cloth, filament winding, or organic (or inorganic) veils as subsequent layers of glass in order to achieve the desired wall thicknesses. For some applications, the aforesaid fabric materials may be impregnated with graphite or carbon fibers or even ceramic fibers to provide increased strength and fire resistance.

As shown in FIG. 6E, two spacing elements 208(a), 208(b) are placed on the inner wall portion 206 and the first and second layers 204. The two spacing elements 208(a), 208(b) preferably comprise a compressible material such as rubber. Compressible spacers are desirable in some cases, since layers can shrink during processing and the spacers can conform to dimensional changes during processing. The spacing elements 208(a), 208(b) are held together by tape. The spacing elements 208(a), 208(b) may be strips of rubber that are wrapped around the mandrel 200.

Next, as shown in FIG. 6F, the space between the two spacing elements 208(a), 208(b) is filled with resin and chop stand mat (or other fabric material) and is allowed to cure. Suitable resins and fabric materials are mentioned above.

Next, as shown in FIG. 6G, a layer 210 of chopped strand mat (or other fabric material) and resin covers the entire top of the spacing elements 208 and the intermediate portion 206. The layer 210 may be the same or different resin as the resin used to form the inner wall portion 206. Preferably, the layer 210 is formed using a phenolic resin as phenolic resins have superior fire-resistant properties.

Then, a filament winding layer 212 is then formed on the chopped strand mat and resin layer 210. The filament winding layer 212 may comprise the resins mentioned above, and preferably includes a phenolic resin. The filament winding layer 212 may comprise filament winding glass of any suitable yield (e.g., 250 yield). The filament winding glass may be wet out with resin before being applied to the mandrel 200. The outer wall portion of the slip collar is then formed by the combined layers 210, 212.

Then, the formed composite is cut at points C with a cutting tool such as a saw. The saw may remain stationary while the mandrel 200 rotates the composite. Alternatively, the saw may move while the mandrel and composite remain stationary. Once cut, the cut piece is removed from the mandrel 200, and the first and second spacer elements 204(a), 204(b) are removed, leaving the first and second slot regions. A pair of pliers can be used to pull out the spacer elements 204(a), 204(b) to remove them from the slot regions. Then, the ends of the formed slip collar may be trimmed or sanded as desired. In this way, many slip collars may be made at the same time on a single mandrel.

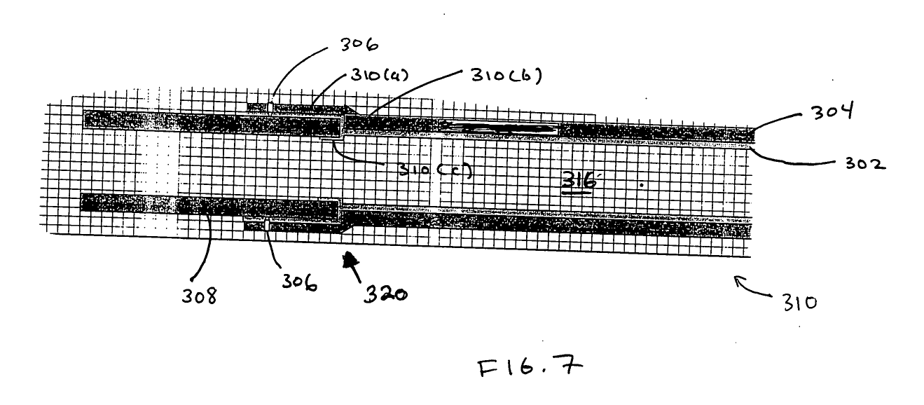

FIG. 7 shows yet another embodiment of the invention. FIG. 7 shows a slip collar 310 with only one slot region at a first end 320. The slip collar 310 has an outer wall portion 310(a), an intermediate portion 310(b), and an inner wall portion 310(c). The opposite second end of the slip collar 310 does not include a slot region. As shown, the slot region at the first end 320 of the slip collar 310 receives a duct section 308 (or alternatively another slip collar of the same configuration as slip collar 310). The duct section 303 (or other tubular structure ) may be 20 foot long or more in some embodiments. The slip collar 310 includes a corrosion barrier or liner layer 302 and an outer filament wound structural wall 304. Both layers 302 and 304 may comprise cured resins and/or fiber-reinforced plastic materials. Although this slip collar 310 has only one slot region, any of the materials, dimensions, and other features described with respect to the slip collars (e.g., with two slot regions) above can be included in this embodiment without departing from the scope of the invention.

Cone shaped set-screws 306 (or other attachment elements) can be used to hold the duct section 308 in position until any adhesive that is present in the slot region at the first end 320 of the slip collar 310 cures. It is possible to start off with 3 set-screws for the smaller diameter duct sections. The number of set screws may be increased as the diameters increase.

The embodiment shown in FIG. 7 has a number of additional advantages over a slip collar with two slot regions. For example, the slip collar 310 with one slot region may be joined end-to-end with other slip collars of the same configuration. Thus, the joined slip collars may form a connecting network of ductwork without the need to use slip collars with two opposing slot regions. This makes the installation of ductwork or other types of tubular articles faster and easier. For example, joining two 5 foot long slip collars of the type shown in FIG. 7 to form a 10 foot assembly would require only one joining step. Joining two 4.5 foot long ducts with a 1 foot slip collar with two opposing slot regions to form an assembly would require two joining steps.

The embodiment shown in FIG. 7 may be formed in the same general manner as described with reference to FIGS. 6A-6G above, except that one of the slot regions would not be formed. For example, to form the embodiment shown in FIG. 7, the same general method could be used, except that one of the spacing elements 208(b) would not be used.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

Moreover, any one or more features of any embodiment of the invention may be combined with any one or more other features of any other embodiment of the invention, without departing from the scope of the invention. For example, although the slip collars shown in FIGS. 4-5 do not show a fluoropolymer film, these slip collar embodiments may also include inner walls with fluoropolymer films.

All patent applications, patents, and publications mentioned above are herein incorporated by reference in their entirety for all purposes. None is admitted to be prior art.

What is claimed is:

1. A slip collar comprising:
(a) a tubular outer wall portion;
(b) a tubular inner wall portion;
(c) an intermediate portion disposed between the tubular outer wall portion and the tubular inner wall portion;
(d) a slot region defined by the tubular outer wall portion and the tubular inner wall portion,
wherein at least one of the tubular outer wall portion, the tubular wall inner portion, and the intermediate portion comprises a fiber reinforced plastic material.

2. The slip collar of claim 1 wherein the tubular outer wall portion and the tubular inner wall portion are each generally cylindrically shaped.

3. The slip collar of claim 1 wherein the tubular inner wall portion comprises a chemically resistant material and the tubular outer wall portion comprises a fire-resistant material.

4. The slip collar of claim 1 wherein the slip collar has only one slot region.

5. The slip collar of claim 1 wherein the tubular inner wall portion is shorter than the tubular outer wall portion.

6. The slip collar of claim 1 wherein the tubular inner wall portion comprises a fluoropolymer material.

7. The slip collar of claim 1 wherein the inner wall portion comprises a cured vinyl ester resin and the outer wall portion comprises a cured phenolic resin.

8. The slip collar of claim 1 further comprising an adhesive composition in the slot region.

9. The slip collar of claim 8 wherein the adhesive composition comprises a novalac or an epoxy resin.

10. A slip collar comprising:
(a) a tubular outer wall portion;
(b) a tubular inner wall portion;
(c) an intermediate portion disposed between the tubular outer wall portion and the tubular inner wall portion,
(d) a first slot region defined by the tubular outer wall portion and the tubular inner wall portion; and
(e) a second slot region defined by the tubular outer wall portion and the tubular inner wall portion,
wherein at least one of the tubular outer wall portion, the tubular wall inner portion, and the intermediate portion comprises a fiber reinforced plastic material, and
wherein the first and second slot regions face away from each other.

11. The slip collar of claim 10 wherein the tubular outer wall portion and the tubular inner wall portion are each generally cylindrically shaped.

12. The slip collar of claim 10 wherein the tubular inner wall portion comprises a chemically resistant material and the tubular outer wall portion comprises a fire-resistant material.

13. The slip collar of claim 10 wherein the slip collar is adapted to join two duct sections.

14. The slip collar of claim 10 wherein the tubular inner wall portion is shorter than the tubular outer wall portion.

15. A duct assembly comprising:
(a) the slip collar of claim 10;
(b) a first duct including a first end inserted into the first slot region; and
(c) a second duct including a second end inserted into the second slot region.

16. A method for joining ducts comprising:
(a) providing the slip collar of claim 10;
(b) depositing a first adhesive composition in the first slot region;
(c) depositing a second adhesive composition in the second slot region;
(d) inserting a first end of a first duct in the first slot region; and
(e) inserting a second end of a second duct in the second slot region.

17. A method for making a slip collar, the method comprising:
(a) forming a tubular inner wall portion;
(b) forming an intermediate portion;
(c) forming a tubular outer wall portion, and
(d) forming a slot region defined by the tubular outer wall portion and the tubular inner wall portion,
wherein at least one of the tubular outer wall portion, the tubular inner wall portion, and the intermediate portion comprises a fiber reinforced plastic material.

18. The method of claim 17 wherein the slot region is a first slot region and wherein the method further comprises:
(e) forming a second slot region that is defined by the tubular outer wall portion and the tubular inner wall portion, wherein the second slot region opposes the first slot region.

19. The method of claim 18 further comprising, before (b):
placing a first spacer element on the formed tubular inner wall portion and placing a second spacer element on the formed tubular inner wall portion, wherein the first spacer element and the second spacer element are spaced from each other, and wherein in (b), the intermediate portion is formed between the first spacer element and the second spacer element.

20. The method of claim 19 wherein the inner wall portion is formed using a vinyl ester resin and the outer wall portion is formed using a phenolic resin.

21. The method of claim 19 further comprising, before (b):
placing a first spacer element on the formed tubular inner wall portion and placing a second spacer element on the formed tubular inner wall portion, wherein the first spacer element and the second spacer element are spaced from each other, and wherein in (b), the intermediate portion is formed between the first spacer element and the second spacer element, and
wherein forming the tubular outer wall portion comprises depositing a fiber reinforced resin composition on the first spacer element, the second spacer element, and the intermediate portion.

22. The method of claim 19 wherein forming the tubular outer wall portion further comprises using a filament winding process.

23. The method of claim 19 wherein forming the first slot region comprises removing the first spacer element and forming the second slot region comprises removing the second spacer element.

24. The method of claim 17 wherein the tubular inner wall portion, the intermediate portion, and the tubular outer wall portion are formed on a mandrel.

25. The method of claim 17 further comprising placing a release film on a mandrel prior to (a).

26. The method of claim 17 wherein the slip collar is for joining a pair of air ducts together.
